(19) United States
(12) Patent Application Publication
(10) Pub. No.: US 2025/0099318 A1
(43) Pub. Date: Mar. 27, 2025

(54) Medical Chair Walker

(71) Applicant: Reginald Keith Sapp, Clinton, MD (US)

(72) Inventor: Reginald Keith Sapp, Clinton, MD (US)

(21) Appl. No.: 18/750,758

(22) Filed: Jun. 21, 2024

(51) Int. Cl. A61H 3/04

(52) U.S. Cl. CPC A61H 3/04; A61H 2003/046

(57) ABSTRACT

The Medical chair Walker FIG. 1 is an invention with hand brakes FIG. 1(A). The chair has a seat FIG. 1(C) for resting and wheels FIG. 1(B) for easy traveling. Its height will adjust FIG. 1(F) (G) for each customer.

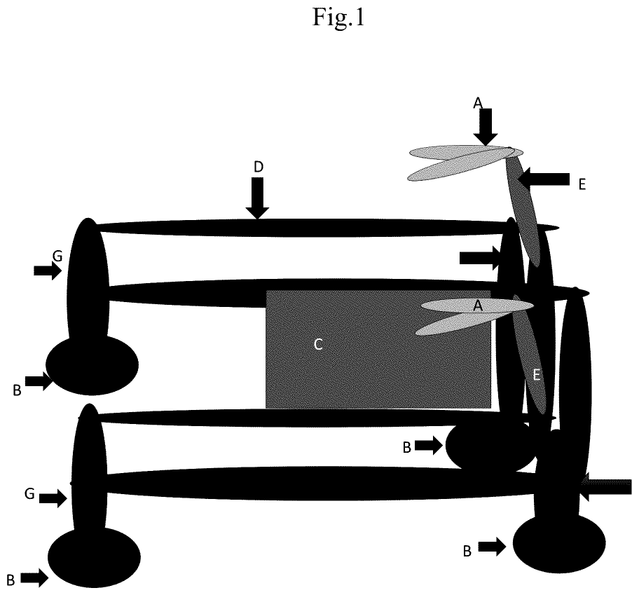

The hand brakes FIG. 1(A) were configured from a 10-speed bicycle.

A traveling Medical Chair Walker FIG. 1 for anyone who needs support to walk, finger exercise and rest while traveling by foot.

The is a medical walker chair that's has the compacity to move 5 lb to 2000 lbs+ with the use of wheel FIG. 1(B) on the bottom and hand brake FIG. 1(A) to stop. The chair is stop by the hand brakes FIG. 1(A) and if need to rest, the seat FIG. 1(C) is there to sit and rest.

The device allows the owner to walk with support using the guides FIG. 1(D) to exercise or just enjoying walking using their own legs.

The hand brake FIG. 1(A) is helpful for all and aids Arthritis patents. The device has four legs FIG. 1(F)(G) with wheels FIG. 1(B) on all four legs. The guides FIG. 1(F)(G) telegraphs up and down for height.

The hands brakes FIG. 1(A) and the hand brake guide FIG. 1(E) are used, to supports the walking to a point and from a point. They can stop and rest with the seat FIG. 1(C) that is built into the walker.

1. We founded in nursing home that the elderly patients were using walkers that they had to pick up and put down to walk with.
The research in airplane wheels and landing results in building a model and putting wheels FIG. 1(B) on them. Also, in nursing home it was understood that elderly patient needed to sit to bath.
It was incorporated in the invention of the Medical Chair Walker with Wheels FIG. 1(B) and Hand Brake FIG. 1(A). It was researched that Arthritis was a big problem with the elderly.
In judo, the gripping of the gee and finger strength. In weight training we work with a hand grip to strengthen the fingers for pull up in exercising. We also found that in gymnastic on the equipment that hand grip and finger strength in important against Arthritis. This research also allowed me to test a hand brake from a bicycle (10 speed).
